(19) United States
(12) Patent Application Publication
(10) Pub. No.: US 2011/0268261 A1
(43) Pub. Date: Nov. 3, 2011

(54) METHOD OF USING PREFIX AND SUFFIX FOR IDENTIFYING USER OF A CALLING TERMINAL

(76) Inventor: Moonseub Lee, Pohang (KR)

(21) Appl. No.: 13/055,149

(22) PCT Filed: Jul. 21, 2009
(86) PCT No.: PCT/KR09/04031

§ 371 Date: Jun. 20, 2011

(30) Foreign Application Priority Data
Jul. 22, 2008 (KR) 10-2008-0070939

(51) Int. Cl. H04M 3/42

(52) U.S. Cl. 379/177

(57) ABSTRACT

The present invention relates to a method that, when users who share one terminal or a plurality of terminals and one calling number or a plurality of calling numbers use individualized database information to utilize communication services, assigns a user identification number that identifies each of the service users in the same user group, attaches the user identification number to the service identification number in the form of a prefix and a suffix, provides the user identification number as a means whereby both an exchange and a server identify a user by the number inputted by the user when a phone is used, and classifies and saves information on each service user, thereby ensuring convenience and security when the user uses communication service. The present invention relates also to a computer-readable recording medium whereon is recorded a program to realize such functions.

### BACKGROUND OF THE INVENTION

1. Field of the Invention

In case of establishing individualized database of each of communication service users in a switching system, an Internet server, a web site, an intelligent peripheral and the like in a communication network and making an access to them, convenience and security are required. When a user wants to receive a mail as a voice, or to obtain information of interest such as weather, stocks, and luck via a communication terminal by using VAD (Voice Activated Dialing) for automatically establishing a connection to a called person via a voice command after connection to the individualized database is made, or voice recognition, it is necessary to verify his own identity by inputting a PIN (Personal Identification Number) or a password.

But, a user must enter a PIN or a password according to a voice guide after pressing a service identification number and then connecting to a database.

Therefore, the procedures are very complicated and there are also inconveniences in employing the procedures in a communication service because of a plurality of digits. Further, they require much efforts and time. When using stored information by connecting to the individualized database of users via communication terminals such as a mobile phone, or wire/wireless phones and the like, or using a value added telecommunication services such as an automatic telephone connection via voice recognition, a voice portal, and a home automation, making convenient access and ensuring security are required. In these cases, level of security is generally, deteriorated. The present invention is related to a method for accomplishing convenient access and high-level security, and a recording medium recording the method to a computer.

2. Description of the Related Art

Like nationwide representative numbers of an intelligent network service, a prefix and a suffix similar to “a service identification number+an identification number of a called person” are employed by allocating four digits for designating a called group in a service identification number (for example, 1577, 1588 and etc.).

The distance calls such as out-of-town-call and an international call are managed as a format of “a local number+a telephone office number+a circuit number.” Generally, a telephone number is used only for identifying a called person or identifying services. Since there are no functions to identify a calling person in a telephone number, it is necessary to input a required PIN or a password according to a voice guide for identifying a calling person after connecting to a communication service providing system using an individualized database. But, input information such as a PIN or a password and the like are commonly formed as a format of approximately 10 digits for identifying all users subscribing to a communication service or because of security problem. There are inconveniences that much effort are required when employing them in the communication services or the communication added services which are frequently used, and it takes much time to input them. Further, after inputting a service identification number, a process for inputting them according to a voice guide requires much time and thus it is very inconvenient and troublesome.

In some cases, ANI (Automatic Number Identification) or CID (Caller Identification) and the like is automatically required and is used in a switching system. But, these identification systems are used for identifying a calling line or a calling terminal, but they are not able to identify the users legally sharing a calling line or a calling terminal.

There is a method for identifying the users legally sharing a calling line or a calling terminal via a calling authentication in a communication service using voice recognition such as a telephone service automatically connected voice recognition, a voice portal, and a home automation, and the like. But, when the number of the sharing users reaches several hundreds or thousands of people, there are many difficulties in providing a real-time service because of much time required in verifying the users, and precision of the verification.

The present invention relates to a method for identifying each of a plurality of users legally sharing a calling line (lines) or a calling terminal (terminals), and also is related to a method for making a convenient access to the individualized information of users and using them. In particular, the present invention relates to a method using body's characteristics such as a voice print, a fingerprint, pulses, an iris and etc. of an individual person, and relates to a field applying particular information of an individual person by combining a signal network, Internet, a public telephone network, and DB management technology.

### SUMMARY OF THE INVENTION

Since the total number of users is commonly enormously large in a value added telecommunication service provided in a public network, it is not practical to make an access to individualized database by applying recognition technology such as a speaker recognition, iris recognition, and fingerprint recognition. In order to solve this problem, method such as a PIN or a password has been used, but these methods generate another problems and inconveniences. It is necessary to find a method for identifying a calling person without making efforts and consuming time for inputting information such as a PIN or a password of approximately 10 digits according to a voice guide for identifying a calling person after connecting to a communication service providing system using an individualized database.

When combining CID technology with technologies such as a speaker recognition, and an iris recognition, and a fingerprint recognition, and then making an access to an individualized database, the number of users in a same calling number group exceeds two or three figure like hospitals, schools, government offices, enterprises and so on, a real-time services or a commercial services could not be provided smoothly due to time required for recognizing and verifying the users, and accuracy level of identification. Therefore, it is indispensable to make an access to a database of a user himself as soon as the user inputs a telephone number or a service identification number. In addition, after making an access to the database of the user himself, it is also essential to devise a method for enhancing security level by judging whether a user is user himself or not based on speaker recognition, iris recognition, or fingerprint recognition.

The present invention relates to a method for identifying each of a plurality of users legally sharing a calling line (lines) or a calling terminal (terminals), and also relates to a method for convenient access to the individualized information of users and a method for convenience using them. In particular, the present invention is applied to a method using body's characteristics such as a voice print, a fingerprint, pulses, an iris and etc. of an individual person, and to a communication service using particular information of an individual person by combining a signal network, Internet, a public telephone network, and DB management technology.

In connection with a particular communication service or a complex communication service including various kinds of functions, when N (N 1) users of M (M 1) users to have a legal right to share the communication terminals (wire/wireless phones, a mobile phone, PDA and the like) of L ((L 1), or the assigned calling numbers want to establish and use a database of individualized person, after designating phone numbers of L as a common first Key, assigning a user identification number of a calling number group having K digits (K is equal or greater than the digits of M which is the number of users.) using a second Key, designating the second Key as the assigned user identification number, a user stores, builds up and uses the individualized database of the user himself. A user attaches a user identification number more than one digit assigned in this method to a communication service identification number as a prefix or a suffix, and utilizes the user identification number like a telephone number as a format “a service identification number+a user identification number”.

For example, like a home including 5 family members, and having the service identification number of an automatic telephone connection via speech recognition is “411”, a user, “TOM” for which “3” is assigned as the user identification number. He uses an automatic telephone connection service via speech recognition, a stored identification reference pattern of TOM and a caller identification pattern extracted from the utterance of “Smith mobile phone ” are recognized and identified by speaker identification of text independent after pressing “411+3” and speaking “Smith's mobile phone”. Then, a judgment whether the voice is a user himself or not is made, and if it is true, the text contents of “Smith mobile phone” is recognized via speech recognition such as speaker dependent speech recognition, and a receiving phone number is extracted. Calling line is connected to the extracted receiving telephone number via an intelligent network or an Internet network or a telephone network.

In case of assigning a user identification number of K digits, a user identification number is formed such that a user may not feel inconveniences by adding digits not less than 3 digits in order to enhance security level. In a case that security level is sufficiently strengthened due to the added digits, a caller identification procedure is an item of option. Further, like an Internet telephone, when attaching a user identification number such as a prefix or a suffix in a communication network processing packet data, a user uses the user identification number like a telephone number by adding the identification number as a format “a user identification number+a service identification number”.

A computer-readable recording medium recording a program for realizing the function provided by the afore-mentioned method in a communication service, and a system realizing the function can be constructed independently.

When using a provided communication services based on utilizing the individualized database, it is possible to input “a service identification number+a user identification number” all at once without inputting a PIN or a password according to a voice guide after inputting the service identification number. Therefore, a burdensome process for inputting a PIN or a password according to a voice guide after the process of inputting “a service identification number” is eliminated and it is possible to identify a calling user without time-consuming efforts. Further, since the number of digits of a user identification number is smaller than that of a PIN or a password, it is very convenient in utilizing or memorizing.

It is possible to classify calling numbers or calling terminals of one group to which a legal use right is given into some groups and to utilize the classified groups. Further, the users can divide their positions according the classified groups and enable their positions to belong to a plurality of groups.

If a user utilizes a communication terminal after attaching a user identification number to a service identification number, when making an access to the individualized database of a user, it is possible to change 1:N identification process between one test data provided by a communication service user and stored reference data of N, into 1:1 verification process to confirm whether the user is himself or not, in the conventional organism recognition technology such as a speaker recognition, an iris recognition, and a fingerprint recognition. But, in this case, it is possible to prevent a possibility that security level is reduced due to deterioration of accuracy if N is very large, to enhance real-time service and to curtail the delay time of a service by remarkably reducing the amount of calculation or the time for calculation required for identification. Further, if adding one digit to three digits in order to reinforce security level of a user identification number, a verification procedure of organism recognition itself can be omitted or can be done both.

The present invention can guarantee required security sufficiently as above, and can also secure conveniences of use.

### BRIEF DESCRIPTION OF THE DRAWINGS

The above and other aspects, features and advantages of the present invention will be more apparent from the following detailed description taken in conjunction with the accompanying drawings, in which:

FIG. 1 is a diagram illustrating an example to establish an individualized database by utilizing a user identification number assigned according to the present invention.

### DETAILED DESCRIPTION OF EMBODIMENTS OF THE PRESENT INVENTION

Hereinafter, embodiments of the present invention will be described with reference to the accompanying drawings. In the following description, the same elements will be designated by the same reference numerals although they are shown in different drawings.

As speech recognition service development team which consists of 13 members using the same calling number group(three telephone numbers is considered as one “02-526-6189” group.) including three calling telephone numbers such as “02-526-6090”, “02-526-6080” and “02-526-6189” provides “a voice activated dialing service (“1582-XXX”) of a personal phonebook” in which the service identification number is “1582”, a case is considered that “111”, “212”, “133”, “155”, “588” are assigned to Goo Myung Wan, Jin Young Min, Kim Jae In, Kim Mi Kyung, Kim Moon Shik, as a user identification number respectively. First of all, an identification number “000” is assigned for registering a user identification number, an identification number “888” is assigned for connection in a calling terminal in which a user identification number of a user himself is not registered and an identification number “999” is assigned for guide. 13 users registers a user identification number of a user himself according to guide of “1582-000”, and then register their individual information and other changed information after connecting to “1582-XXX” of each user. In case of using the registered individual information, a user can utilize them via connection to “1588-XXX”. When connecting to a database of a user in a communication terminal except the calling terminals where a user identification number of a user himself is registered and “1588-888” is inputted, if a user inputs a registered calling number of a user himself according to a voice guide, that is, “input a registered calling telephone number including a local number”, he can use a provided service.

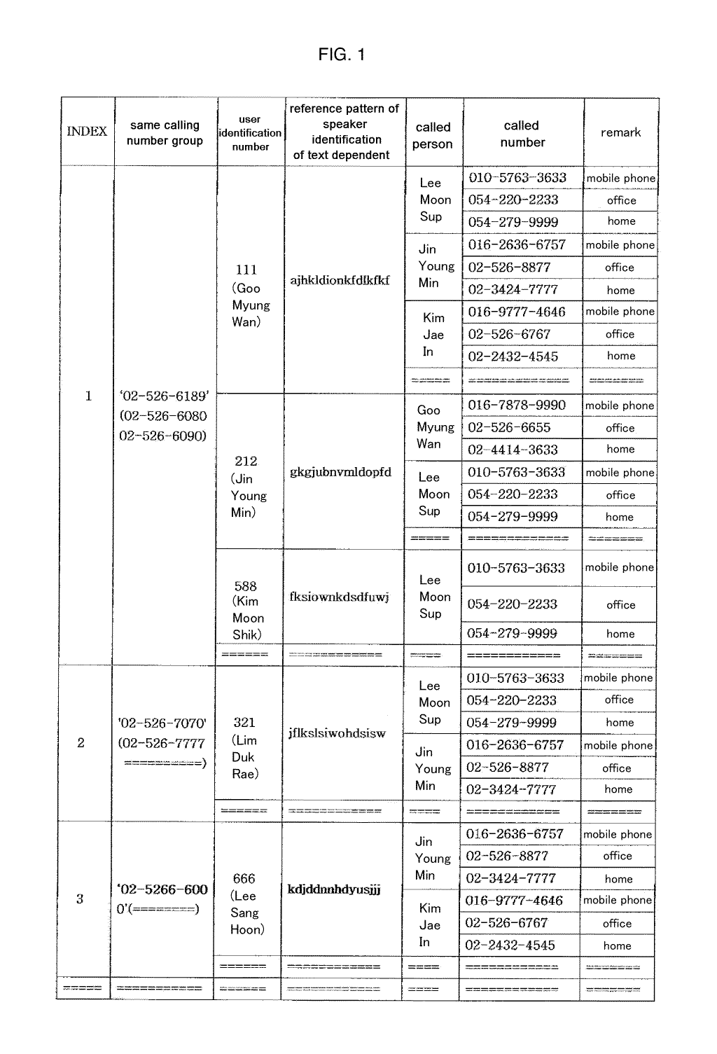

FIG. 1 illustrates an embodiment of the present invention and when Goo Myung Wan tries to use “a voice dialing service of an individual phonebook” using one telephone number of three calling telephone numbers, that is, “02-526-6090”, “02-526-6080” and “02-526-6189” registered as the same calling number group, if he presses “1582-111”, a switching system recognizes the calling number (CID), judges the number as the same calling number group (“02-526-6189”) of INDEX_1, recognizes “111” and then, Goo Myung Wan having a user identification number of “111” is recognized among 13 users in the same calling number group (“02-526-6189”). Further, when Goo Myung Wan calls “Lee Moon Sup's mobile phone”, it is verified whether a user is a user himself based on the stored reference pattern for a caller identification concerning Goo Myung Wan and a test pattern of a text independent speaker verification extracted from the uttered voice “Lee Moon Sup's mobile phone”. Then if verification is true, Lee Mun Sup and the mobile phone are recognized by speech recognition and then, a connection is made to Lee Moon Sup's mobile phone. In this way, a user identification number attached as a format of a suffix or a prefix before or after the service identification number can be used to identify each user in the same user group using the same calling number group.

When Goo Myung Wan wants to connect to a plurality of Internet portal sites or Internet surfing sites via one telephone number of three calling telephone numbers, that is, “02-526-6090”, “02-526-6080” and “02-526-6189”, if he presses “1582-111” and speaks “a site name” according to a voice guide and subsequently, when connecting to a site recognized by speech recognition, it is possible for a user to make a connection without any other inconveniences by attaching the individual information such as a site connection information of Goo Myung Wan which is additionally stored in FIG. 1, and sending them to a site.

In realizing home automation, when it is assumed that a service connection number of home automation is “1583”, and “-X” of one figure is allocated as a user identification number of each of family members or a user identification number having “-XXXX” of four digits for enhancing an encoding function are used, it is possible to reinforce a user verification function in case of connecting to a site at a remote distance.

A computer-readable recording medium recording a program for realizing a function provided by the above method in a communication service, a system realizing the function can be constructed independently.

A phone number “YYYY-XXXX” of eight digits are provided to a phone subscriber according to a subscribed region based on a numbering system for identifying a receiving person, and thus a user who tries to make a call uses the phone number. The service identification number of the nationwide representative number of 1588 of KT (Korea Telecommunication) is formed as “1588-XXXX”, and the number (XXXX) of four digits for identifying a called person is allocated at the rear positions and they are used as a nationwide representative number. The membership service of 1644 of KT is formed as “1644-XXXX”, and the number (XXXX) of four digits which are positioned after a service identification number for identifying a meeting are attached and are used as a membership service number.

In this way, the above-mentioned numbers are attached as a format of “-XXXX” after a telephone office number or a communication service identification number and are used for identifying a called person's terminal or a called subscriber.

According to the present invention, a user identification number can be a combination of K digits of numbers, characters, special characters. User identification number can be attached before or after a service identification number of 3-4 digits. Further, a method for identifying each user of a plurality of users (below, “a same user group”) legally sharing one terminal or a plurality of terminals, one calling number or a plurality of calling numbers (below, “a same calling number group”) is provided. Further, all calling numbers of the same calling number group are designated as a first key based on such a method, and information of each user in the same user group of the same calling number group is classified and stored with a user identification number of K digits as a second key. In the same user group of the same calling number group of a family less than 10, since a need for each member of the group to hide his own information is reduced, digits of K=1-K=3 are used as a user identification number for storing each member's information.

In the same user group of the same calling number group like company offices consisting of several tens of members, digits of K=2-K=4 can be used as a user identification number for classifying and storing each member's information. In this case the security level is guaranteed to a certain degree. In the same user group of the same calling number group like schools and government offices consisting of hundreds or thousands of members, digits of K=3-K=5 can be used as a user identification number for classifying and storing each member's information. Therefore, the information can be utilized while maintaining security to a certain degree. In an organization where it is not necessary to keep individual information of each member secret, the digits of a user identification number corresponding to that of the maximum number of the members are required (for example, if the members are nine persons, K=1 and if the members are 13 persons, K=2.). In an organization where it is necessary to keep individual information of each member secret, the digits of a user identification number larger by 1-3 digits than that of the maximum number of the members are required (for example, if the members are nine persons, K=2-K=3, if the members are 10-99 persons, K=3-K=4, and if the members are 100-999 persons, K=4-K=5.).

A computer-readable recording medium recording a program for realizing the function provided by the afore-mentioned method in a communication service, and a system realizing the function can be configured independently.

In connection with a same user group sharing a same calling number group separated in terms of a distance and using a virtual private network, it is possible to provide a communication service based on an individualized database after assigning a user identification number to each user. Further, the present invention can be applied to all fields where it is necessary to identify each user in order to make a convenient access to an individualized database of each user under environments of a plurality of users having the legal use rights concerning home automation, voice portals, ubiquitous city, voice commands for controlling robot operations and the like.

A computer-readable recording medium recording a program for realizing the function provided by the afore-mentioned method in a communication service, and a system realizing the function can be configured independently.

While the invention has been shown and described with reference to certain embodiments thereof, it will be understood by those skilled in the art that various changes in form and details may be made therein without departing from the spirit and scope of the invention as defined by the appended claims.

What is claimed is:

1. A communication service providing method for identifying a specific user by classifying sharing users when a plurality of users (a same user group) who have a legal right to share more than one terminal or more than one calling number (a same caller group) establish individualized database of each user, and the plurality of users use particular communication services such as a speech recognition portal, an automatic call connection via speech recognition and the like, or a communication service including various kinds of functions,
the method comprising:
a assigning step for assigning a user identification number as a prefix or a suffix before or after a service identification number provided by a communication service provider;
a storage step for assigning calling numbers of the same caller group as a first key, assigning the assigned use identification number as a second key, designating the reference data for an organism recognition of the user as a third key, and then generating information of each user of the same calling number group and storing under the first key; and a use step for using methods such as access, search, comparison, update, deletion and the like with respect to an individualized and stored information of each user by attaching the user identification number provided in this manner and including more than one digit to a communication service identification number like a prefix and a suffix, and using together with a telephone number as a format of “a service identification number+a user identification number”.

2. The communication service providing method of claim 1, wherein the assigning step is characterized in that a user identification number having a number below 4 digits is assigned according to size of the same user group.

3. The communication service providing method of claim 2, wherein the assigning step is characterized in that a user identification number is assigned by adding digits at least 1 digit(s) to a service identification number for encoding provided according to size of the same user group for security among the users of the same user group.

4. The communication service providing method of claim 1, wherein the assigning step is characterized in that a user identification number is registered via an Internet server or a user identification number of a predetermined digits is entered via a voice guide of a telephone.

5. The communication service providing method of claim 1, wherein the storage step is characterized in that an individual information of each user is classified as an identification number and then is registered by connecting to an Internet server using an ID and a password or after inputting “a service identification number+a user identification number” designated for registration via a telephone, the inputted numbers are stored.

6. The communication service providing method of claim 1, wherein the storage step is characterized in that one data selected from a reference data for speaker recognition, a reference data for iris recognition, and a reference data for fingerprint recognition, or any combination thereof are stored and used as a reference data for an organism recognition.

7. The communication service providing method of claim 1, wherein the use step is characterized in that if a user enters an organism recognition information such as a voice, an iris, a fingerprint and the like after inputting his own identification number as “a service identification number+a user identification number”, first of all, the same calling number group is specified according to a calling number, an individual information of a user is specified according to a user identification number, and whether the user is himself or not can be recognized by comparing an organism recognition test data extracted from the inputted organism recognition information, and a reference data for an organism recognition of the user one by one.

8. A computer-readable recording medium that record a program to realize a function for identifying users in the same user group, and wherein the program includes each step of a method for identifying a specific user by classifying sharing users when a plurality of users (a same user group) who can use a legal right to share more than one terminal or more than one calling number (a same caller group) establish individualized database of each user, and the plurality of users use particular communication services such as a speech recognition portal, an automatic call connection via speech recognition and the like, or a communication service including various kinds of functions,
the method comprising:
a assigning step for assigning a user identification number as a prefix or a suffix before or after a service identification number provided by a communication service provider;
a storage step for assigning calling numbers of the same caller group as a first key, assigning the assigned use identification number as a second key, designating the reference data for an organism recognition of the user as a third key, and then generating information of each user of the same calling number group and storing under the first key; and a use step for using methods such as access, search, comparison, update, deletion and the like with respect to an individualized and stored information of each user by attaching the user identification number provided in this manner and including more than one digit to a communication service identification number like a prefix and a suffix, and using together with a telephone number as a format of “a service identification number+a user identification number”.

9. A communication service system that realizes a function for identifying users in the same user group by using a method for identifying a specific user by classifying sharing users when a plurality of users (a same user group) who can use a legal right to share more than one terminal or more than one calling number (a same caller group) establish individualized database of each user, and the plurality of users use particular communication services such as a speech recognition portal, an automatic call connection via speech recognition and the like, or a communication service including various kinds of functions,
the method comprising:
a assigning step for assigning a user identification number as a prefix or a suffix before or after a service identification number provided by a communication service provider;
a storage step for assigning calling numbers of the same caller group as a first key, assigning the assigned use identification number as a second key, designating the reference data for an organism recognition of the user as a third key, and then generating information of each user of the same calling number group and storing under the first key; and a use step for using methods such as access, search, comparison, update, deletion and the like with respect to an individualized and stored information of each user by attaching the user identification number provided in this manner and including more than one digit to a communication service identification number like a prefix and a suffix, and using together with a telephone number as a format of “a service identification number+a user identification number”.
